(19) United States
(12) Patent Application Publication
(10) Pub. No.: US 2011/0161098 A1
(43) Pub. Date: Jun. 30, 2011

(54) METHOD AND SYSTEM FOR ACCESSING A PLURALITY OF MEDICAL DATA SOURCES

(76) Inventors: Sultan Haider, Erlangen (DE); Martin Haseneyer, Erlangen (DE); Brigitte Stroetmann, Aisch (DE)

(21) Appl. No.: 12/648,339

(22) Filed: Dec. 29, 2009

(51) Int. Cl. G06Q 50/00; G06N 5/02

(52) U.S. Cl. 705/2; 706/47; 706/11

(57) ABSTRACT

An embodiment of the invention explains a method and system for accessing medical data. The method involves providing access to medical data from the plurality of medical data sources and then correlating the medical data from the plurality of sources based on predefined rules. Then a medical expert reviews the correlated medical data by medical expert and associate expert information from the medical expert regarding the correlation of the medical data from different sources to the medical data.

### FIELD

At least one embodiment of the present invention generally relates to medical data, particularly a method and/or system for accessing medical data.

### BACKGROUND

Technological advancement in medical science and information technology lead to an exponential rise in medical information. For example, interne offers an unprecedented source of information. In healthcare facilities, medical data of patients are recorded and stored electronically. The medical data includes images of the body parts of the patient, lab reports, prescriptions for the patient by the physician, procedures done etc. The existence of large number of diseases and the large number of medical reports and images acquired for diagnostics results in exponential growth of medical image data. Advance in medical research also generate an ever growing stream of new medical information, which will result in the formulation of new medical guidelines.

Much of the time, these type of information is complex as well as conflicting and could even misguide a physicians in their judgement and diagnostics if used. Even if large amount of data is available publicly but the authenticity of the available information is very much questionable. Hence it is difficult for the medical practitioner to effectively make use of the medical data.

### SUMMARY

In view of the foregoing, an embodiment herein includes a method for accessing a plurality of medical data sources comprising: providing access to medical data from the plurality of sources, correlating the medical data from the plurality of sources based on predefined rules, reviewing the correlated medical data by a medical expert, and associating expert information from the medical expert regarding the correlation of the medical data from different sources to the medical data.

In view of the foregoing, another embodiment herein includes a system for accessing a plurality of medical data sources comprising: an accessing module for providing access to medical data from the plurality of medical data sources, and a processing module adapted for correlating the medical data from the plurality of sources based on predefined rules enabling a medical expert to review the correlated medical data and associate expert information from the medical expert regarding the correlation of the medical data from different sources to the medical data.

The underlying idea here, regarding at least one embodiment, is to associate expert information to the existing medical data so as to make the medical data simpler i.e. less complex and more effective for practical use. Here the medical data is accessed from the plurality of medical data sources using a predefined rule and then the medical expert associates the more useful expert information on to the medical data.

The term “medical expert” in the context of the embodiments of the invention should be understood as a knowledgeable person, who is in a way related to the field of healthcare services or healthcare products or a person having technical knowledge or experience in the said type of services and/or products.

The term “expert information” will be construed as involving information emanating from the knowledge or understanding or experience of the said medical expert.

Under “predefined rules” is meant system defined or user defined data acquisition rules basically employed in data retrieval systems. This predefined rules also defines the initial correlation of the medical data and based on this initial correlation defined using said predefined rules, the medical data is initially presented to the user.

According to an example embodiment, the predefined rules are adapted to be changed using the expert information. This enables the already existing rules for the data acquisition to be revised based on the expert information, which might result in a more precise or efficient search results.

In an alternate embodiment, associating expert information involves the assignment of metadata to the medical data. The metadata helps in categorizing and relating the medical data so as to have a faster access, when queried for at a later point in time. For example the metadata could be the name of the disease, regional location of the patient, date of publication of the medical data etc.

In another alternate embodiment, the expert infounation is adapted for correlating the medical data in the medical data sources. This enables the proper linking of the medical data sources enabling a wider or elaborate source for medical data, which finally helps in having wider base for the inferences and judgment for an end user.

According to a further aspect of an embodiment of the invention, expert information is adapted for indexing the reliability of the medical data. This enables to provide a sort of rating for the medical data; based on the reliability. The reliability indexing here could be interpreted or based on one or more parameter like correctness, usability, relevance etc. For each parameter there can even be one separate indexing.

According to another aspect of an embodiment of the present invention, the expert information is associated to the medical data by the medical expert using a template based entry form via a user interface. This template acts as a tool enabling the medical expert to associate the expert information to the medical data. For example this could be an Adobe® PDF admin form or any other document template.

According to another aspect of an embodiment of the present invention, the expert information is associated to the medical data by the medical expert using a software application. This enables the medical expert to associate the expert information to the medical data using software applications, which has become the norm of the present day information technology age. For example, one application could be Adobe® “Flash”.

In another alternate embodiment, the correlated medical data after associating expert information is adapted to be presented based on a user definition. The user definition is based on the metadata, correlation between the plurality of medical data sources and reliability of the medical data or a combination of any of these. This basically enables easy and faster accessibility to more simplified and reliable medical data, organized based on the expert information. The user definition could be in a form of a query, which will enable the representation of the medical data to the end user. Best results could be achieved if the user definitions in some way fall in relation to the correlated information. Since the user definitions more or less matches or considers the criteria's associated with the expert information, the presented information could be more relied upon by the end user.

In one aspect of an embodiment of the present invention, the medical data comprises at least one of the clinical data, operational data, technical data and financial data.

In one aspect of an embodiment of the present invention, the plurality of sources comprise at least one of the Clinical guideline database, System utilization database, clinical study database, scientific database and personal medical database.

### BRIEF DESCRIPTION OF THE DRAWINGS

The present invention is further described hereinafter with reference to illustrated embodiments shown in the accompanying drawings, in which:

FIG. 1 illustrates a flowchart representing a workflow representing a method for accessing a plurality of medical data sources according to an embodiment of the invention, and

FIG. 2 illustrates a block diagram of a system for accessing a plurality of medical data sources according to an embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate foul's and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular foul's disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the teens first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

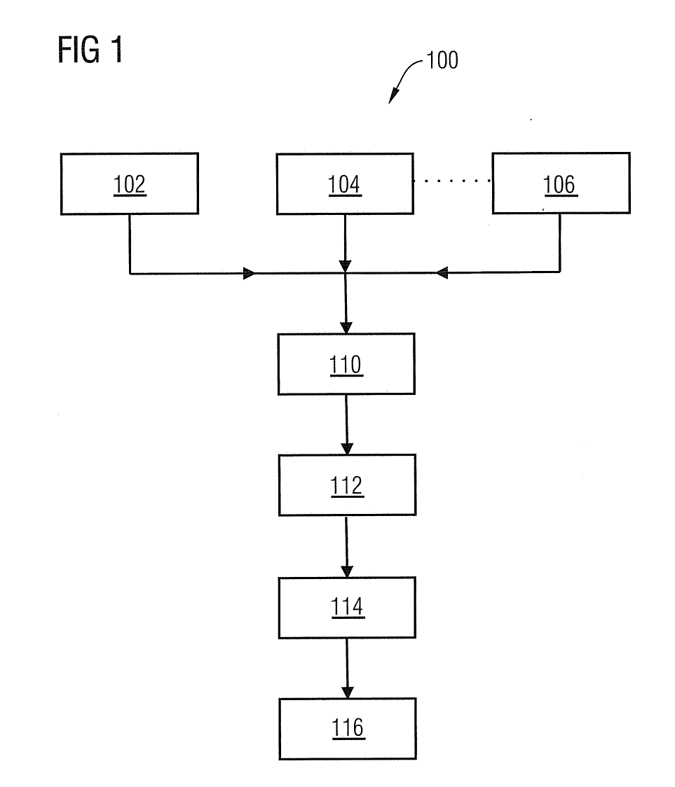

FIG. 1 illustrates a workflow 100 representing a method for accessing a plurality of medical data sources according to an embodiment of the invention. A particular medical facility has data stored at the facility or associated with the facility. The data may be spread across different computer systems, stored in different formats and in different databases. Medical data source 102, medical data source 104, medical data source 106 represents plurality of medical data source in a local or distributed network. The medical data source could be a clinical guideline database, system utilization database, clinical study database, scientific database or a personal medical database. The medical data inside this clinical database includes at least one of the clinical data, operational data, technical data and financial data.

For example, the clinical data referred in the invention includes but not restricted to disease specific clinical quality data, medical information from national institutes responsible for ensuring quality in healthcare, information from Diagnosis-Related Group DRGs from Healthcare Information Systems (HIS) or Radiology Information Systems (RIS), or could be form authorised registers of any society like cardio/stroke/onco registers, or clinical studies database, or from medical guidelines and best-practice assessments and metrics or could be electronic medical records which reflects personalized medical information.

The operational data includes but not restricted to real time system utilization data, performance data of different imaging modalities, etc. Since the operational data is part of the medical data, the medical expert in the present invention for example would include a radiologist, modality specialist etc. The technical data on the other hand includes but not restricted to information from research and development labs, patent databases, scientific database etc. Since technical data is part of the medical data, the medical expert in the present invention for example would include a scientist, patent manager, etc. Financial data on the other hand includes financial performance data based on image acquisition modalities, accounting database of the medical facility, financial performance of clinical facilities etc. Since financial data is part of the medical data, the medical expert in the present invention for example would include a financial analyst, financial administrator etc.

The method first involves accessing medical data from the plurality of medical data sources as shown in step 110. Then the method involves the step of correlating the medical data from the plurality of sources based on predefined rules as shown in step 112. The predefined rules could be system defined or user defined data acquisition rules basically employed in data retrieval systems. This predefined rules also defines the initial correlation of the medical data and based on this initial correlation defined using said predefined rules, the medical data is initially presented to the user.

At step 114 the medical expert reviews the correlated medical data. At step 116, the medical expert associates expert information from the medical expert regarding the correlation of the medical data from different sources to the medical data.

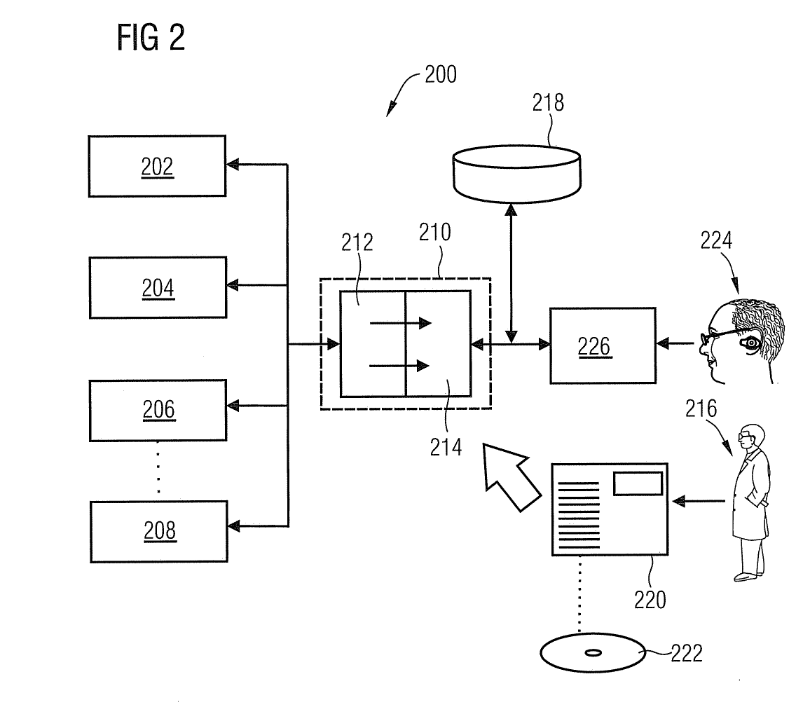

FIG. 2 illustrates a block diagram of a system 200 for accessing a plurality of medical data sources according to an embodiment of the invention. Medical data source 202, medical data sources 204, medical data sources 206 and medical data source 208 represents different medical databases or repositories. There are lots of unstructured, unrelated and complex information in these repositories. Basically these repositories could be at a single place or could be distributed across databases in different geographies. The medical expert can access the medical data sources through the said data handling sub-system 210, which could be console for example a computer or even a wireless communication device. The said data handling sub-system 210 has an accessing module 212 for providing access to medical data from the plurality of medical data sources 202,204,206 and 208. The data handling sub-system 210, further has a processing module 214 adapted for correlating the medical data from the plurality of sources based on predefined rules. In the FIG. 2, the accessing module 212 and the processing module 214 is part of a single data handling sub-system. The accessing module 212 and the processing module 214 can even be realizing using two separate and independent sub systems. The medical expert 216 review the correlated medical data initially provided to him based on the predefine rules and he associates the expert information from the medical expert regarding the correlation of the medical data from different sources to the medical data.

The system 200 further comprises a storage module 218 to store at least one of the medical data, correlated medical data, predefined rule or the expert information. As mentioned the storage module 218, can be used to store the accessed medical data obtained by the accessing module 212. The storage module 218 can even store the predefined rules for the initial access of the medical data. The expert information along with the correlated medical data can also be stored in the storage module 218, for example if the expert want to double check the expert information prior to confirming or if he need to have a preview of the correlation prior to committing the revised information.

As previously mentioned the expert information involves the assignment of metadata to the medical data or can be used for correlating the plurality of medical data sources or could be adapted for indexing the reliability of the medical data. The expert information is associated to the medical data by the medical expert 216 using a template based entry form 220 via a user interface. Also the same could be done using a software application 222.

Practically the whole system is useful only if the correlated information can be used judiciously by the end user 224. The system further comprises a presentation module 226 adapted to present the correlated medical data associated with the expert information based on a user definition. For the useful presentation of medical data the said user definition can be based on the metadata or can be based on the correlation between the pluralities of medical data sources or based on the reliability of the medical data. The user definition is not restricted to these three but can further include any customized or need based user definition of the end user 224.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

### REFERENCE NUMERALS

100 workflow representing a method for accessing a plurality of medical data sources
102 Medical data source
104 Medical data source
106 Medical data source
110 accessing medical data from the plurality of medical data sources
112 correlating the medical data based on predefined rules
114 medical expert reviews the correlated medical data
116 medical expert associates expert information
200 system for accessing a plurality of medical data sources
202 Medical data source
204 Medical data source
206 Medical data source
208 Medical data source
210 data handling sub-system
212 accessing module
214 processing module
216 medical expert
218 storage module
220 template based entry form
222 software application
224 end user
226 presentation module

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for accessing a plurality of medical data sources, comprising:
providing access to medical data from the plurality of medical data sources;
correlating the medical data from the plurality of sources based on rules;
reviewing the correlated medical data by a medical expert; and
associating expert information from the medical expert regarding the correlation of the medical data, from different of the plurality of sources, to the medical data.

2. The method according to claim 1, wherein the rules are adapted to be changed using the expert information.

3. The method according to claim 1, wherein the associating of the expert information involves the assignment of metadata to the medical data.

4. The method according to claim 1, wherein the expert information is adapted for correlating the plurality of medical data sources.

5. The method according to claim 1, wherein the expert information is adapted for indexing the reliability of the medical data.

6. The method according to claim 1, wherein the expert information is associated to the medical data by the medical expert using a template based entry form via a user interface.

7. The method according to claim 1, wherein the expert information is associated to the medical data by the medical expert using a software application.

8. The method according to claim 1, wherein the correlated medical data, after associating expert information, is adapted to be presented based on a user definition.

9. The method according to claim 8, wherein the user definition is based on the metadata.

10. The method according to claim 8, wherein the user definition is based on the correlation between the plurality of medical data sources.

11. The method according to claim 8, wherein the user definition is based on the reliability of the medical data.

12. The method according to claim 1, wherein the medical data comprises at least one of the clinical data, operational data, technical data and financial data.

13. The method according to claim 1, wherein the plurality of sources comprise at least one of the Clinical guideline database, System utilization database, clinical study database, scientific database and personal medical database.

14. A system for accessing a plurality of medical data sources, comprising:
an accessing module to provide access to medical data from the plurality of medical data sources; and
a processing module adapted to correlate the medical data from the plurality of sources based on rules, enabling a medical expert to review the correlated medical data, and to associate expert information from the medical expert regarding the correlation of the medical data from different sources to the medical data.

15. The system according to claim 14, further comprises a storage module to store at least one of the medical data, correlated medical data, rules and the expert information.

16. The system according to claim 14, further comprising a presentation module adapted to present the correlated medical data, associated with the expert information, based on a user definition.

17. The system according to claim 14, wherein the associating of the expert information involves the assignment of metadata to the medical data.

18. The system according to claim 14, wherein the expert information is adapted for correlating the plurality of medical data sources.

19. The system according to claim 14, wherein the expert information is adapted for indexing the reliability of the medical data.

20. The system according to claim 14, wherein the expert information is associated to the medical data by the medical expert using a template based entry form via a user interface.

21. The system according to claim 14, wherein the expert information is associated to the medical data by the medical expert using a software application.

22. The method of claim 1, wherein an accessing module provides access to the medical data and wherein a processing module is adapted to correlate the medical data from the plurality of sources based on the rules, enabling a medical expert to review the correlated medical data, and to associate the expert information.

23. A computer readable medium including program segments for, when executed on a computer device, causing the computer device to implement the method of claim 1.
